(19) United States
(12) Patent Application Publication
(10) Pub. No.: US 2020/0066304 A1
(43) Pub. Date: Feb. 27, 2020

(54) DEVICE-SPECIFIC VIDEO CUSTOMIZATION

(71) Applicant: International Business Machines Corporation, Armonk, NY (US)

(72) Inventors: Hsiao-Yung Chen, New Taipei City (TW); June-Ray Lin, Taipei City (TW); Tzu-Ching Kuo, TAIPEI (TW); Yi-Chun Tsai, TAIPEI (TW)

(21) Appl. No.: 16/113,058

(22) Filed: Aug. 27, 2018

(51) Int. Cl. G11B 27/036; G11B 27/10

(52) U.S. Cl. CPC G11B 27/036; G11B 27/10

(57) ABSTRACT

A real-time customized video can be provided, to a user device such as a cell phone or laptop, through a computer-implemented method. A processor circuit can be used to generate, based upon at least one received user device setting, at least one real-time customized video that is created from and is similar to an original video. Setting information can be received by the processor circuit from a user device from which a view request for the original video was received. A video of the at least one real-time customized videos can be provided to the user device by the processor circuit, based on the setting information received from the user device.

### BACKGROUND

The present disclosure generally relates to video technology, and more specifically, to the generation and providing of videos to mobile computing devices, i.e., “user devices.”

Electronic device users may view videos provided by websites or video players by using various computing devices such as mobile phones, computers and laptops. Various video content providers may provide a large number of videos to meet the viewing preferences of different users having a wide range of electronic devices. A user may also select a video from the large library of videos for viewing according to his own interests.

### SUMMARY

The above summary is not intended to describe each illustrated embodiment or every implementation of the present disclosure.

Embodiments may be directed towards a computer-implemented method for providing, to a user device, a real-time customized video. The method can include generating, with at least one processor circuit, based upon at least one received user device setting, at least one real-time customized video that is created from and is similar to an original video. The method can also include receiving, with the at least one processor circuit, setting information from a user device from which a view request for the original video was received. The method can also include providing, to the user device, with the at least one processor circuit, based on the setting information received from the user device, a video of the at least one real-time customized video.

Embodiments may also be directed towards a system for providing, to a user device, a real-time customized video. The system can include at least one processor circuit, a memory electrically coupled to the at least one processor circuit and a set of computer program instructions stored in the memory and executed by the at least one processor circuit in order to perform a method. The method can include generating, based upon at least one received user device setting, at least one real-time customized video that is created from and is similar to an original video. The method can also include receiving setting information from a user device from which a view request for the original video was received and providing, to the user device, based on the setting information received from the user device, a video of the at least one real-time customized video.

Embodiments may also be directed towards a computer program product comprising a computer-readable storage medium having program instructions embodied therewith. The computer-readable storage medium may not be a transitory signal per se. The program instructions are executable by a computing device to perform a method for providing, to a user device, a real-time customized video. The method can include generating, based upon at least one received user device setting, at least one real-time customized video that is created from and is similar to an original video. The method can also include receiving setting information from a user device from which a view request for the original video was received. The method can also include providing, to the user device, based on the setting information received from the user device, a video of the at least one real-time customized video.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example computing node, according to embodiments of the present disclosure.

FIG. 2 depicts a cloud computing environment, according to embodiments consistent with the figures.

FIG. 3 depicts abstraction model layers, according to embodiments consistent with the figures.

FIG. 4 is a flow diagram depicting an example computer-implemented method for video customization, according to embodiments consistent with the figures.

FIGS. 5A-5C depict example customized screens used to display customized videos, according to embodiments consistent with the figures.

FIG. 6 is a flow diagram depicting an example video generation method, according to embodiments consistent with the figures.

FIG. 7 is a flow diagram depicting an example video synchronization method, according to embodiments consistent with the figures.

FIG. 8 depicts an example video synchronization method, according to embodiments consistent with the figures.

FIG. 9 depicts an example video synchronization method, according to embodiments consistent with the figures.

While the invention is amenable to various modifications and alternative forms, specifics thereof have been shown by way of example in the drawings and will be described in detail. It can be understood, however, that the intention is not to limit the invention to the particular embodiments described. On the contrary, the intention is to cover all modifications, equivalents, and alternatives falling within the spirit and scope of the invention.

In the drawings and the Detailed Description, like numbers generally refer to like components, parts, steps, and processes.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It can be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms, e.g., mobile phones, laptops, and PDAs.

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction, e.g., country, state, or datacenter.

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service, e.g., storage, processing, bandwidth, and active user accounts. Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser, e.g., web-based e-mail. The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components, e.g., host firewalls.

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns, e.g., mission, security requirements, policy, and compliance considerations. It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability, e.g., cloud bursting for load-balancing between clouds.

A cloud computing environment is service oriented with a focus on statelessness, low coupling, modularity, and semantic interoperability. At the heart of cloud computing is an infrastructure that includes a network of interconnected nodes.

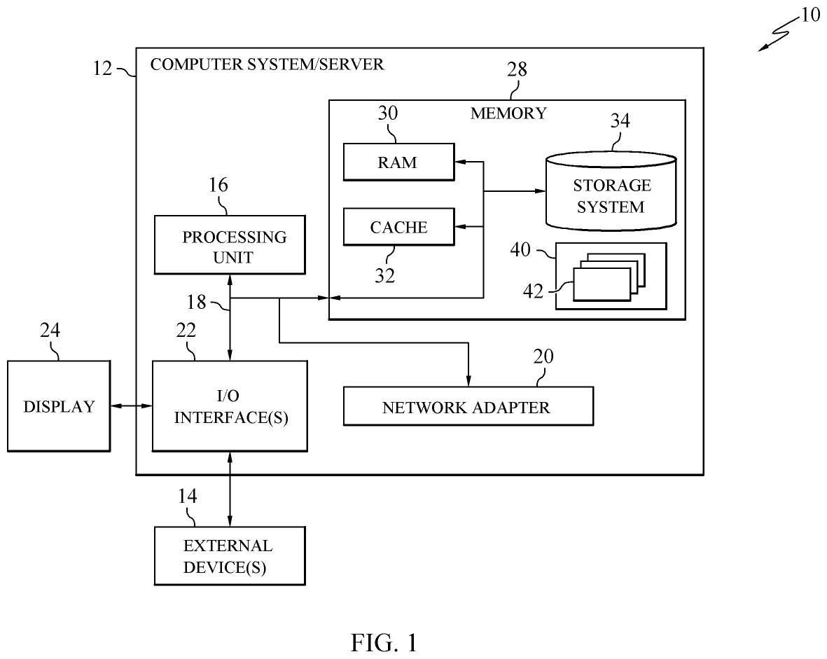

Referring now to FIG. 1, an example of a cloud computing node is depicted. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic user device such as a communication device, which is operational with numerous other general purpose or special purpose computing system environments or configurations. Examples of well-known computing systems, environments, and/or configurations that can be suitable for use with computer system/server 12 include, but are not limited to, personal computer systems, server computer systems, thin clients, thick clients, hand-held or laptop user devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 can be described in the general context of computer system-executable instructions, such as program modules, being executed by a computer system. Generally, program modules can include routines, programs, objects, components, logic, data structures, and so on that perform particular tasks or implement particular abstract data types. Computer system/server 12 can be practiced in distributed cloud computing environments where tasks are performed by remote processing devices that are linked through a communications network. In a distributed cloud computing environment, program modules can be located in both local and remote computer system storage media including memory storage devices.

As depicted in FIG. 1, computer system/server 12 in cloud computing node 10 is depicted in the form of a general-purpose computing device. The components of computer system/server 12 can include, but are not limited to, one or more processor circuits or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media, not depicted and typically called a “hard drive”. Although not depicted, a magnetic disk drive for reading from and writing to a removable, non-volatile magnetic disk, e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set, e.g., at least one, of program modules that are configured to carry out the functions of embodiments of the disclosure.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the disclosure as described herein.

Computer system/server 12 can also communicate with one or more external devices 14 such as a keyboard, a pointing device, a display 24, etc.; one or more devices that enable a user to interact with computer system/server 12; and/or any devices, e.g., network card, modem, etc., that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network, e.g., the Internet, via network adapter 20. As depicted, network adapter 20 communicates with the other components of computer system/server 12 via bus 18. It can be understood that although not depicted, other hardware and/or software components could be used in conjunction with computer system/server 12. Examples, include, but are not limited to: microcode, device drivers, redundant processing units, external disk drive arrays, RAID systems, tape drives, and data archival storage systems, etc.

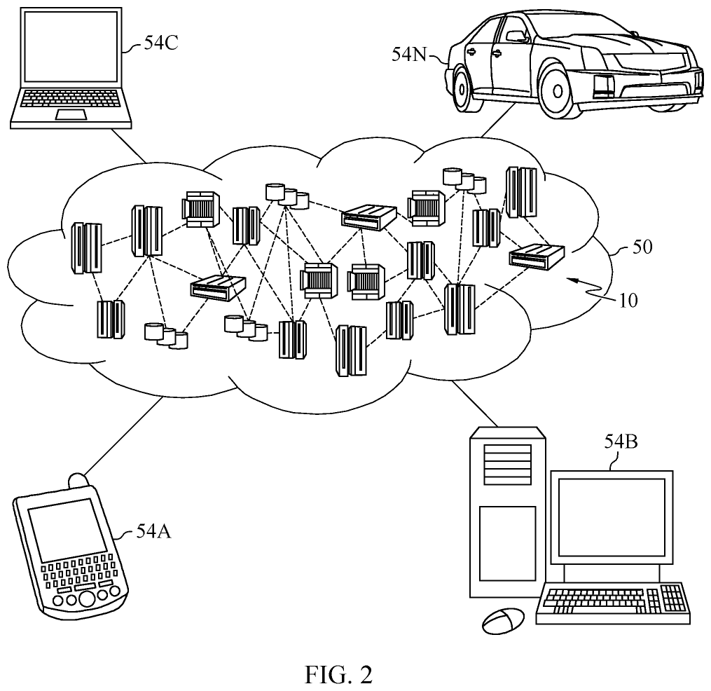

Referring now to FIG. 2, illustrative cloud computing environment 50 is depicted. Cloud computing environment 50, as depicted, includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not depicted) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted in FIG. 2 are intended to be illustrative only and that computing nodes 10 and cloud computing environment 50 can communicate with any type of computerized device over any type of network and/or network addressable connection, e.g., using a web browser.

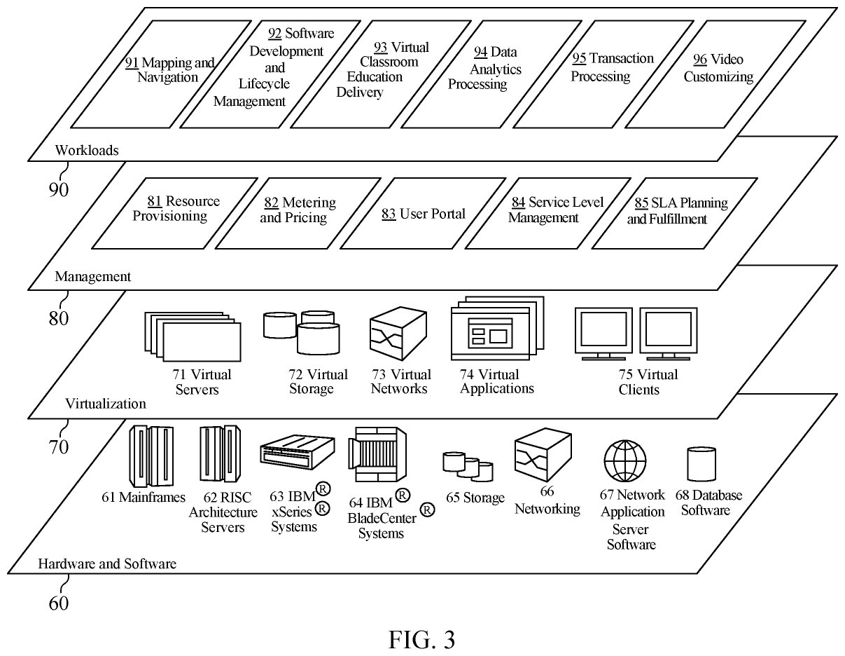

FIG. 3 depicts a set of functional abstraction layers provided by the cloud computing environment 50, FIG. 2. It can be understood in advance that the components, layers, and functions depicted in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and video customizing 96.

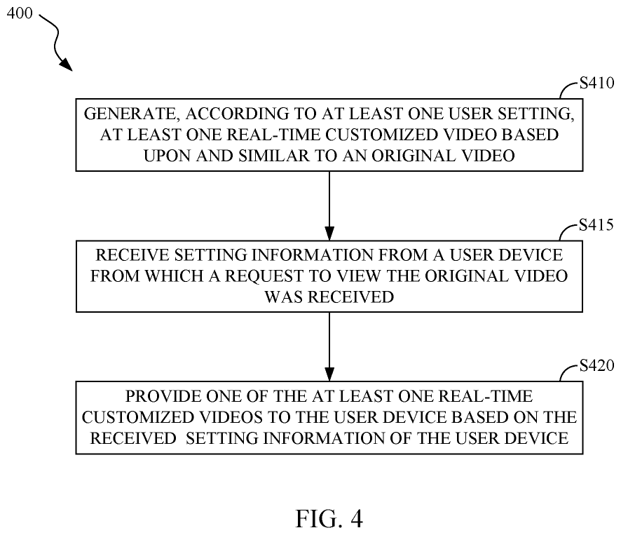

Some embodiments of the present disclosure may be implemented as the program/utility 40 or the program modules 42 of the computer system/server 12 of FIG. 1, or as the video customizing 96 of the workloads layer 90 of FIG. 3. Some embodiments of the present disclosure, including aspects described with respect to FIGS. 4-9, can be implemented using one or more processing circuits, e.g., as part of computer system/server 12.

With reference now to FIGS. 4-9, some embodiments of the present disclosure are described below. A scenario of providing a video to different users will first be introduced, where both user “A” and user “B” request to view the same video using their respective mobile phones. The content of the video can be a demonstration of how to use a mobile application on a mobile phone. In the following description, the same video selected by the user A and the user B is also referred to as an “original video.”

In the original video, the mobile application is demonstrated using the Android operating system (OS)®. That is, each demonstration operation in the original video of how to use the mobile application, e.g., opening a login page, entering a name and password, tapping on the login button, etc., is relevant to the Android OS®. The demonstration operations can also be referred to as “video operations” in the following description.

In contrast, the mobile phone of the user A is configured to run iOS®, while the mobile phone of the user B is configured to run Windows Phone OS® (the above mentioned Android OS® belongs to Google Co., Ltd., iOS® belongs to Apple Co., Ltd. and Windows Phone OS® belongs to Microsoft Co., Ltd.). The following Table 1 depicts corresponding operating systems installed on mobile phones used by the user A and the user B.

Since the same original video is selected by both user A and user B, they can view exactly the same video content. That is, the original video including demonstration operations for the Android OS® can be provided to and played on the mobile phones of user A and user B that are configured to run iOS® and Windows Phone OS® respectively, as depicted in Table 1.

TABLE 1

| | User A | User B |
|---|---|---|
| OS of mobile phones | iOS ® | Windows Phone OS ® |
| Videos provided to users | Original video | Original video |
| | with Android OS ® | with Android OS ® |

However, due to different user configurations, e.g., operating systems, layouts and language settings, found on different mobile phones, the demonstration in the original video created for the Android OS® may not be directly applied or relevant to the mobile phone configured with iOS® or Windows Phone OS®. In this case, the user A and the user B may not fully understand how to use the mobile application on their own mobile phones from viewing the original video.

In some cases, it is possible to prepare, in advance, several customized videos similar to the original video, according to a finite set of pre-considered user device settings. A customized video among the pre-prepared customized videos can be selected and provided, i.e., played, to a user. According to embodiments, however, a mobile phone can include a very large number of possible user device settings. This very large number of possible user device settings can result from the use habits of various types of mobile device users. In this case, it is difficult to prepare, in advance, a very large number of customized videos corresponding to the very large set of user device settings. Thus, suitable customized videos related to specific user device settings may not be able to be provided to certain users.

There exists, therefore, a need to provide a customized video, similar to the original video, that corresponds to certain user device settings among the very large set of user device settings. Instead of providing the same original video to different users, regardless of the configuration of their mobile user device, a customized video, similar to the original video, but varying according to certain corresponding user device settings can be provided to each user respectively, according to embodiments. Therefore, the user experience for viewing a video can be improved through viewing of videos customized according to the user's particular mobile device and its associated operating system and user device settings.

FIG. 4 is a flow diagram depicting an example computer-implemented method 400 for video customization, according to embodiments of the present disclosure. As depicted in FIG. 4, the method 400 can include a video generation operation S410, a setting information receiving operation S415 and a video providing operation S420.

In the video generation operation S410, at least one real-time customized video, created from, and similar to an original video, is generated based on at least one received user device setting. In the setting information receiving operation S415, setting information can be received from a user device from which a view request for the original video was received. In the video providing operation S420, one of the at least one real-time customized videos can be provided to the user, based on the setting information received from the user device. The original video described in the present disclosure can include a variety of types of videos, such as a demonstration video, a video advertisement, a live program, a video conference, and so on.

In some embodiments, the at least one user device setting used in the video generation operation S410 can be any user device setting of a computing device that is used for playing a video, e.g., a mobile phone, a computer or a laptop. The example user device settings can include a type of OS, a language preference setting, a screen layout of the computing device, or any other settings or combination thereof.

In some embodiments, the user device setting(s) can be determined based on statistical information obtained or collected from a large amount of setting information of many users using various computing devices. In some embodiments, when a user selects/requests a video for viewing, the setting information received from the user device can be received and saved as a user device setting. The saved user device setting can be subsequently used to generate a customized video for a certain type of user having similar user device setting information. In some embodiments, the setting information can be received in response to receiving the user's permission. For example, when a user selects a video for viewing, a dialog box displaying “Do you allow us to collect your setting information?” can be displayed, and the setting information can be received after the user selects a “Yes” in the dialog box.

In some embodiments, the at least one user device setting can include settings that are most commonly used. The most commonly used settings can be most commonly used within a certain time period, i.e., the “most frequently used” settings. For example, in a case where the at least one customized video is generated for playing on mobile phones, the at least one user device setting can include most used OS types such as Android OS®, iOS® and Windows Phone OS®.

In some embodiments, the setting information received from the user device in the setting information receiving operation S415 and used in the video providing operation S420 can include at least one of the specific OS type, a language setting, or a layout, e.g., screen area layout, of the user's computing device. In some embodiments, the setting information received from the user device can be received from the computing device used by the user for video viewing. In some embodiments, the setting information of different users can be collected as the statistical information for determining the at least one user device setting used in the video generation operation S410.

In some embodiments, the customized video can be a video customized in real-time based on the received user device settings. However, it can be appreciated that the customization of the video may not be strictly performed in real-time. For example, a delay can be allowed during the real-time customization. In the following description, unless otherwise specified, the real-time customized video according to the present disclosure is simply referred to as a “customized video.”

In some embodiments, in the video providing operation S420, the customized video can be provided to the user in response to a request from the user device for viewing a customized video similar to the original video. In some embodiments, in the video providing operation S420, the customized video can be “pushed” to the user when the user selects to view the original video.

As can be seen from the above, according to the method 400, instead of directly providing the user with the original video which the user requests to view, a customized video similar to the original video can be provided, based on the setting information received from the user device. In this way, even if different users request to view the same original video, the videos actually provided to each user can be uniquely customized for each user, and can be different from each other. Therefore, the user experience for viewing a video can be improved through customization. In some embodiments, the method 400 can be a service in a cloud environment and in some embodiments, the method 400 can be a client application installed in a computing device.

More details of the method 400 are described below. In some embodiments, the one of the at least one customized videos to be provided to the user in the video providing operation S420 can be generated, in the video generation operation S410, based on a user device setting of the at least one user device setting that is the most similar to the setting information received from the user device. In some embodiments, the at least one customized video can be generated in advance before being provided to the user.

The following Table 2 depicts the operating systems of mobile phones used by the user A and the user B. Table 2 is in accordance with the example described with reference to Table 1, in which the original video is a demonstration of how to use a mobile application on a mobile phone, and wherein the mobile phone of user A is configured with iOS® and the mobile phone of the user B is configured with Windows Phone OS®, and a request is made to view the original video.

The at least one user device setting can include the OS(s) installed on the mobile device(s), i.e., Android OS®, iOS® and Windows Phone OS®, which can be the most often used OS types. Further, three customized videos similar to the original video, i.e., customized video 1 for Android OS®, customized video 2 for iOS® and customized video 3 for Windows Phone OS®, can be generated based upon these user device settings.

As for the user A, since the operating system of the mobile phone is iOS®, the setting information of user A can include an operating system type of iOS®. In this case, the customized video 2 with iOS®, in which the user device setting is the most similar, in this example, the same, to the setting information received from the user device A, can be provided to the user A, instead of the original video with Android OS®. Similarly, the customized video 3 with Windows Phone OS® can be provided to the user B.

The following Table 2 depicts the videos provided to the user A and the user B. Comparing Table 2 with Table 1, it can be seen that instead of providing the same original video to the user A and the user B, as depicted in Table 1, different videos customized for the user A and the user B, respectively, can be provided based on their respective setting information as depicted in Table 2. Therefore, the user A and the user B can be able to more fully understand how to use the mobile application on their own mobile phones through playing the videos customized to their particular device(s).

TABLE 2

| | User A | User B |
|---|---|---|
| OS of mobile phones | iOS ® | Windows Phone OS ® |
| Videos provided to | Customized video 2 | Customized video 3 |
| users | for iOS ® | for Windows Phone OS ® |

In the above example, described in reference to Table 2, the most similar user device setting is a setting that is exactly the same as the setting information received from the user device. However, in some use cases, it can be understood that the most similar user device setting can include a setting that is similar but not exactly the same as the setting information received from the user device. For example, in a case where setting information received from a user device is special and unique, and there exists no user device setting which is exactly the same as the setting information, a user device setting that is the most similar to the setting information received from the user device can be used in the video providing operation S420 to provide a customized video to the user.

In some embodiments, the criterion for determining the most similar user device setting to the setting information received from the user device can be predetermined according to actual situations. Further, the criterion can be adjusted according to the at least one user device setting and the setting information received from the user device.

In some embodiments, the customized video can be provided to the user, e.g., the user A or B, in response to a request from the user device for viewing the customized video similar to the original video. Without the request, the original video would still be provided to the user. In some embodiments, a customized video can be pushed to the user without the user's request.

In some embodiments, the at least one user device setting can be obtained from the setting information received from the user device which sent a request to view the original video. In some embodiments, the setting information received from the user device received in the setting information receiving operation S415 can be received before the video generation operation S410 and can be used as a user device setting of the at least one user device setting that is used for generating one of the at least one customized video in the video providing operation S420 to be provided to the user. These embodiments are suitable for the cases in which a customized video is generated in real-time based on the user device setting while being provided to the user.

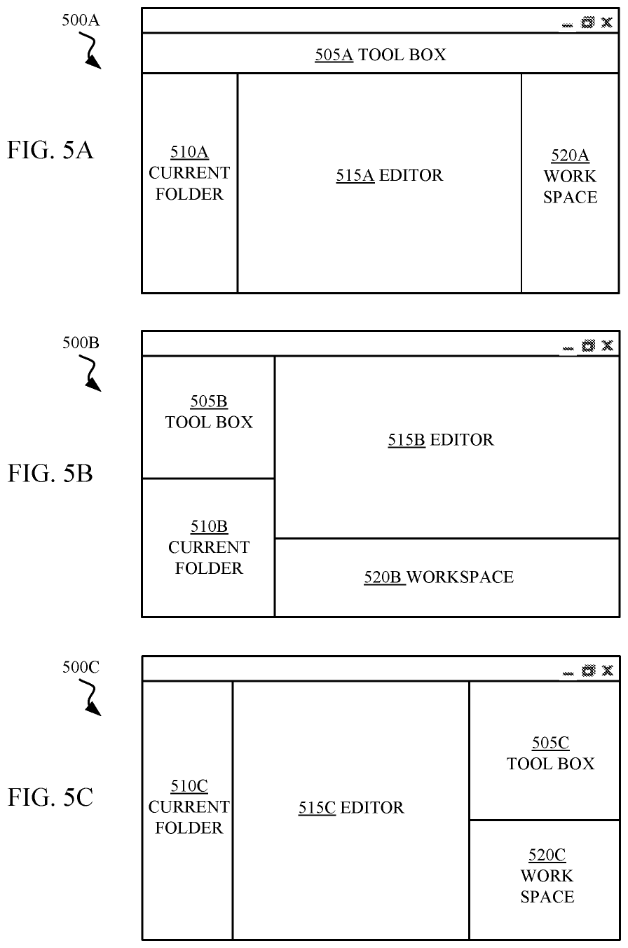

FIGS. 5A-5C are schematic diagrams depicting customized screens for displaying videos during a video conference, according to embodiments of the present disclosure. In the video conference, there are a presenter “A” and two attendees, e.g., attendee “B” and attendee “C”. The presenter A is sharing his integrated development environment (IDE) to the attendees B and C.

FIG. 5A depicts the example customized screen of the presenter A during the video conference, wherein the screen displays the IDE layout 500A of the presenter A, which includes a tool box 505A, a current folder 510A, an editor 515A and a workspace 520A. Other portions of the IDE layout 500A are omitted in FIG. 5A for ease of illustration. The layout 500A can be adjusted according to the use habits of the presenter A. The screen of the presenter A during the video conference can correspond to the original video described according to the method 400.

The attendees B and C can request to view the screen of the presenter A during the video conference. However, according to the present disclosure, instead of directly providing the screen of the presenter A to the attendees B and C, the screen of the presenter A can be customized for the attendees B and C, respectively. The customized screens for the attendees B and C can correspond to the at least one customized video described according to the method 400.

In order to provide a customized screen for the attendee B, the setting information of the attendee B, i.e., the IDE layout information, can be first received. Then, the setting information of the attendee B can be used as the user device setting for generation of the customized screen similar to the screen of the presenter A. Further, during the generation of the customized screen for the attendee B, the customized screen can be provided to the attendee B in real-time.

FIG. 5B depicts the customized screen for the attendee B, including the IDE layout 500B. The IDE layout 500B includes a tool box 505B, a current folder 510B, an editor 515B and a workspace 520B which respectively correspond to the tool box 505A, the current folder 510A, the editor 515A and the workspace 520A depicted in FIG. 5A. The IDE layout 500B of the attendee B is different from the IDE layout 500A of the presenter A, while the content depicted in each portion of the IDE layout 500B is the same as that of the IDE layout 500A.

As for the attendee C, similar processes can be performed so that a customized screen including the IDE layout 500C can be provided to the attendee C. As depicted in FIG. 5C, the IDE layout 500C can include a tool box 505C, a current folder 510C, an editor 515C and a workspace 520C which respectively correspond to the tool box 505A, the current folder 510A, the editor 515A and the workspace 520A depicted in FIG. 5A. The IDE layout 500C of the attendee C is different from the IDE layout 500A of the presenter A, while the content depicted in each portion of the IDE layout 500C is the same as that of the IDE layout 500A.

It can be seen from FIGS. 5A-5C that during the video conference, the attendees B and C do not have to force themselves to acclimate to the presenter A's original video, including his own IDE layout. Instead, each attendee can adopt his personalized IDE layout to the customized video. Therefore, the attendee can view the video where the presenter is using the attendee's personal IDE layout, and thus the user experience can be customized and thus, improved.

In some embodiments, the customized screen for the attendee, e.g., the attendee B or C, can be pushed to him during the video conference without the attendee's request. In some embodiments, the customized screen for the attendee can be provided to him in response to his request for viewing the customized screen. Without the request, the original screen can be provided to him for viewing.

In some embodiments, the attendee can choose whether to use his own IDE layout or the presenter's IDE layout at the beginning of the video conference. In some embodiments, the layout provided to the attendee can be switched during the video conference according to the attendee's selection. For example, the attendee can choose to use his own IDE layout at the beginning of the video conference, while he can select to switch to the presenter's layout at any time during the video conference.

In some embodiments, the setting information of different users, e.g., the presenter A and the attendees B and C, can be registered in a profile collecting server (PCS). During the video conference, the setting information can be obtained from the PCS and used as user device settings for generation the customized videos.

In some embodiments, if the attendee B joins the video conference in the middle of the video conference, the customized video for the attendee B can still be generated similarly to the original video from the beginning of the video conference. Further, the customized video for the attendee B can be fast-forwarded so as to catch up with the current progress of the video conference.

In some embodiments, during the video conference, if the attendee B prefers the layout of the presenter A, the attendee B can request to obtain the setting information of the presenter A from the PCS, and adopt the setting information of the presenter A to his own IDE for future use.

In the above description, the cases where all portions of the original video can be customized as the customized video are explained. However, in some embodiments, the original video can include a customizable portion and a non-customizable portion. For example, in the case where the original video is a demonstration of how to use the mobile application, as described with reference to Table 2, the customizable portion of the original video can be the foreground of the original video in which the mobile application is demonstrated, which can be customized based on different user device settings. Further, the non-customizable portion can be the background of the original video, which can be non-customizable and can be the same for different user device settings.

In some embodiments, each of the at least one customized videos can be generated by combining a customized portion of the customized video and the non-customizable portion of the original video, wherein the customized portion of the customized video can be generated based on one of the at least one user device setting.

In some embodiments, green-screen technologies can be used for combining the customized portion of the customized video into the non-customized portion of the original video. For example, the customizable portion of the original video can be processed as green-screen so that the customized portion of the customized video can be embedded into the green-screen to generate the customized video. In the cases where the original video includes a customizable portion and a non-customizable portion, the method 400 can only be performed on the customizable portion of the original video in order to reduce the complexity of generating the customized video.

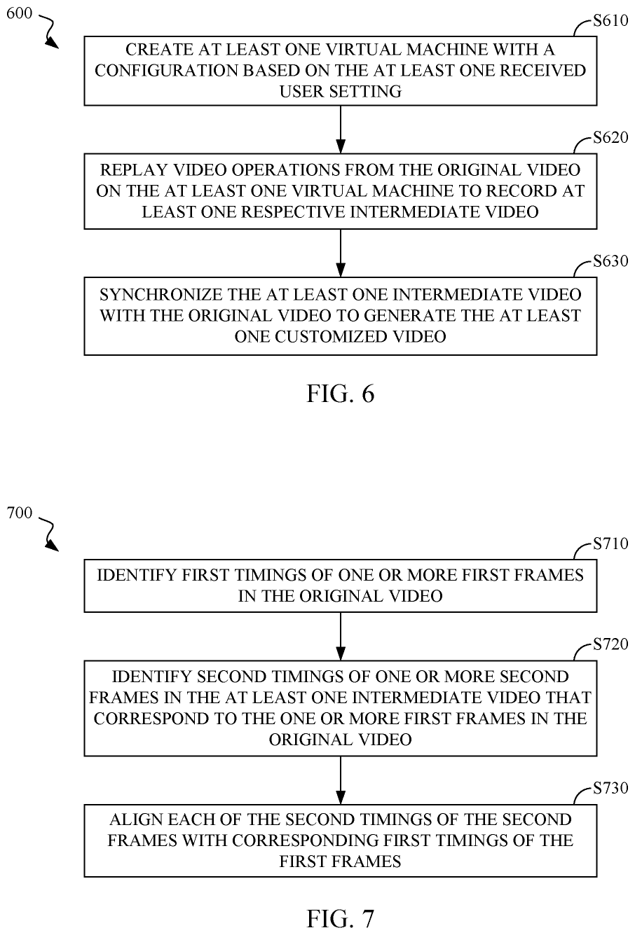

FIG. 6 is a flow diagram depicting an example video generation method 600, according to embodiments of the present disclosure. The video generation method 600 can be used for implementing the video generation operation S410 of method 400, FIG. 4. As depicted in FIG. 6, the video generation method 600 can include a virtual machine (VM) creation operation S610, an intermediate video recording operation S620 and a synchronization operation S630.

In the VM creation operation S610, at least one VM is created and configured based upon the at least one user device setting. Such a VM, configured with a user device setting, can be used to simulate the environment of a computing device for playing a video. For example, a VM configured with an operating system type of iOS® can be used to simulate the computing device with iOS®. As another example, a VM configured with an IDE layout, as depicted in FIG. 5B, can be used to simulate the IDE environment of the attendee B. In some embodiments, user device settings can be saved as VM configurations for configuring VMs. The VM configurations can be pre-registered in the PCS for configuring VMs.

In the intermediate video recording operation S620, video operations from the original video can be replayed on the at least one VM to record as at least one intermediate video, respectively. In some embodiments, the video operations can be extracted from the original video according to the content of the original video.

In some embodiments, the video operations can involve interactive operations with the content of the video. For example, in a case where the original video is a demonstration of how to use a mobile application on a mobile phone, the video operations, also referred to as “demonstration” operations, can include operations such as opening the login page, entering a name and password, and tapping on a “login” button.

The example video operations can include keyboard operations such as a keyboard press, a keyboard input, mouse operations such as a mouse movement, left-click, right-click, double-click and drag. Example video operations can also include a screen touch, such as a tap, touch and hold, drag and drop, an audio in the original video, such as an utterance of “clicking the login button,” and a motion performed in the original video, such as a gesture pointing to and tapping on the login button.

The video operations from the original video can be detected by various technologies. For example, the Java Developer's Kit (JDK) and the “.NET” framework can provide libraries to detect different kinds of interactive operations, which can be integrated as an event handler within the present disclosure, in order to detect video operations. As another example, audio recognition technologies can be used for recognizing the audio within the original video, and an utterance indicating an interactive operation, such as an utterance of “clicking the login button,” can be recognized as a video operation. As a further example, motion recognition technologies can be used for recognizing the motions in the original video, and a motion indicating an interactive operation, such as a gesture pointing to and tapping on the login button, can be recognized as a video operation.

In some embodiments, the video operations from the original video can be provided to each VM for replaying the video operations. For example, a plug-in can be installed on the computing device for playing the original video. At least one of the various technologies for detecting the video operations, as described above, can be integrated into the plug-in for detecting the video operations. Further, the plug-in can send the detected video operations to each VM in order to facilitate the VM to replay the video operations with its own VM configuration.

In some embodiments, the replaying of the video operations can be automatically implemented by using programming languages such as an Extensible Markup Language (XML) script, a Java program, and any other programming language(s). Through the programming languages, the video operations, e.g., the operations as described above, can be automatically replayed on each VM.

In some embodiments, the replaying of the video operations can be implemented manually. For example, in a case where the number of the video operations is small, a person can perform the video operations on a VM manually to replay these video operations. During the replaying of the video operations on a VM, a video including the video operations can be generated on the VM, and can be recorded as an intermediate video. In the synchronization operation S630, the at least one intermediate video can be synchronized with the original video to generate the at least one customized video. In this way, the user can view the customized video which is synchronized with the original video without delay or speed-up.

The synchronization operation 630 can be particularly suitable for the cases where the real-time requirements are very strict, such as the case of the video conference described with reference to FIGS. 5A-5C. However, in some embodiments, in the cases that the real-time requirements are not very strict, such as the case of demonstrating a mobile application as described with reference to Table 2, the synchronization operation S630 can be omitted, and the intermediate video recorded in operation S620 can be used as the customized video.

The customized video described above can be a real-time customized video. However, it can be appreciated that the customized video generated in the video generation method 600 may not necessarily be customized in real-time. In some embodiments, the customized video can be prepared in advance, based on the user device setting(s).

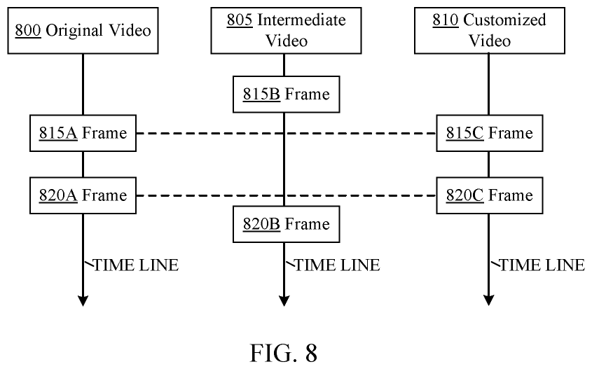

Referring to FIGS. 7 and 8, an example synchronization method according to embodiments is introduced and described. The synchronization method can be used for implementing the synchronization operation S630 of method 600, FIG. 6. FIG. 7 is a flow diagram depicting an example synchronization method 700, according to embodiments. FIG. 8 is a schematic diagram depicting the synchronization method 700.

As depicted in FIG. 7, the synchronization method 700 can include a first timing identifying operation S710, a second timing identifying operation S720 and an aligning operation S730. In operation S710, first timings of one or more first frames, e.g., frame 815A and frame 820A depicted in FIG. 8 in the original video 800, can be identified. The first timings of one or more first frames can include the timings of frame 815A and frame 820A. FIG. 8 depicts the original video 800 playing along the direction of the arrow of the time line, which means that the frame 815A is played before the frame 820A in the original video 800.

In some embodiments, the one or more first frames can be determined according to actual situations so long as they can be used to synchronize the original video with the intermediate video. In some embodiments, each of the one or more first frames in the original video can involve a video operation. In some embodiments, the video operations from the original video can be used to determine the one or more first frames.

In operation S720, second timings of one or more second frames in the at least one intermediate video corresponding to the one or more first frames in the original video can be identified. In the following description, a second frame corresponding to a first frame can indicate that the content of the second frame and the first frame are the same.

FIG. 8 depicts one intermediate video 805 including frame 815B and frame 820B. Second timings of one or more second frames can include the timings of the frame 815B and frame 820B, wherein frame 815B is played before frame 820B in the intermediate video 805.

The frame 815B and the frame 820B in the intermediate video 805 correspond to the frame 815A and the frame 820A in the original video 800 respectively. However, as depicted by the dashed line in FIG. 8, the timing of the frame 815B is not aligned with the timing of the frame 815A, and the timing of the frame 820B is not aligned with the timing of the frame 820A.

In operation S730, each of the second timings can be aligned with its corresponding first timing. The aligned intermediate video can be used as the customized video.

As depicted in FIG. 8, the frame 815B of the intermediate video 805 is slower than the frame 815A of the original video 800. In order to align the timing of frame 815B with the timing of the frame 815A, the intermediate video 805 can be fast-forwarded so that the frame 815B can be aligned with the frame 815A. The aligned frame 815B of the intermediate video 805 corresponds to the frame 815C of the customized video 810. As depicted by the dashed line in FIG. 8, the frame 815C of the customized video 810 is synchronized with the frame 815A of the original video 800.

As also depicted in FIG. 8, frame 820B of the intermediate video 805 is faster than the frame 820A of the original video 800. In order to align the timing of frame 820B with the timing of frame 820A, the intermediate video 805 can be slowed down so that the frame 820B can be aligned with the frame 820A. The aligned frame 820B of the intermediate video 805 corresponds to the frame 820C of the customized video 810. As depicted by the dashed line in FIG. 8, the frame 820C of the customized video 810 is synchronized with the frame 820A of the original video 800. It can be understood that the fast-forwarding can also include jumping over some frames of the intermediate video for the alignment, while the slowing down can also include pausing the intermediate video for a certain time period for the alignment. In FIG. 8, it is depicted that one of the at least one intermediate video is synchronized with the original video. However, in some embodiments, at least two intermediate videos need to be synchronized with the original video.

In some embodiments, an original video can include more than one original sub-video interacting with each other, where each of the original sub-videos corresponds to a different user device setting. For example, the original video can be a peer-to-peer video relating to a computing device of user A and a computing device of user B, wherein the computing devices of the user A and the user B are interacting with each other. As another example, the original video can be a client-server video relating to a server and a plurality of clients, wherein the server and the plurality of clients are interacting with each other.

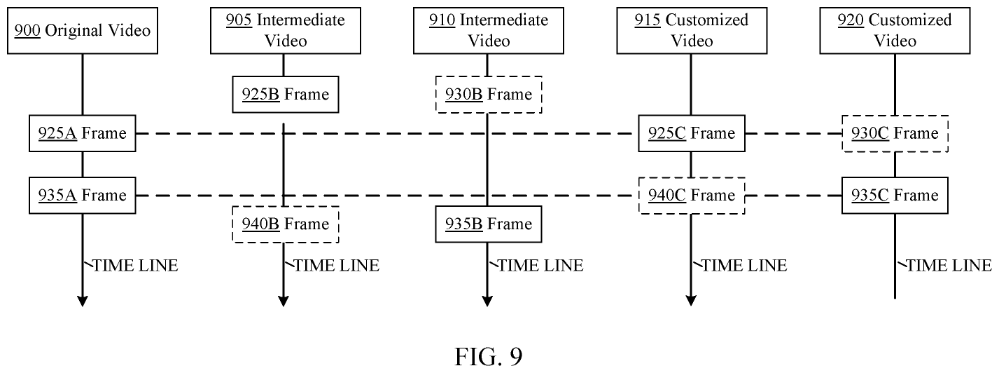

In these cases, corresponding video operations from the original video can be replayed on at least two virtual machines to record as at least two intermediate videos respectively. Therefore, the at least two intermediate videos need to be synchronized with the original video. The method of synchronizing the at least two intermediate videos can be described with reference to FIG. 9.

FIG. 9 is a schematic diagram depicting a video synchronization method, according to embodiments of the present disclosure. According to embodiments, at least two intermediate videos can be synchronized with the original video and combined to generate the customized video. As depicted in FIG. 9, the original video 900 includes two frames, i.e., the frame 925A and the frame 935A, wherein the frame 925A and the frame 935A correspond to different user device settings and correspond to frames in different intermediate videos 905 and 910 respectively. That is, the frame 925A of the original video 900 corresponds to the frame 925B of the intermediate video 905, and the frame 935A of the original video 900 corresponds to the frame 935B of the intermediate video 910. The intermediate videos 905 and 910 are to be synchronized with the original video 900.

In FIG. 9, the frame 940B, depicted as a dashed block, is a frame of the intermediate video 905 which is played at the same timing as the frame 935B of the intermediate video 910. Further, the frame 930B, depicted as a dashed block, is a frame of the intermediate video 910 which is played at the same timing as the frame 925B of the intermediate video 905.

During the synchronization of the intermediate videos 905 and 910 with the original video 900, the timings of the frames 925A and 935A of the original video 900, the timing of the frame 925B of the intermediate video 905 corresponding to the frame 925A of the original video 900, and the timing of the frame 935B of the intermediate video 910 corresponding to the frame 935A of the original video 900 are identified.

As depicted in FIG. 9, the frame 925B of the intermediate video 905 is slower than the frame 925A of the original video 900. In order to align the timing of the frame 925B with the timing of the frame 925A, the intermediate video 905 can be fast-forwarded so that the frame 925B is aligned with the frame 925A. The aligned frame 925B of the intermediate video 905 corresponds to the frame 925C of the customized video 915.

Further, since the intermediate videos 905 and 910 can interact with each other, only fast-forwarding the intermediate video 905 can cause a mismatching of the frame 930B of the intermediate video 910 with the frame 925B of the intermediate video 905. In order to avoid the mismatching, the intermediate video 910 is fast-forwarded simultaneously with the intermediate video 905.

In this way, as depicted by the dashed line in FIG. 9, not only the frame 925C of the customized video 915, but also the frame 930C of the customized video 920, which corresponds to the frame 930B of the intermediate video 910, is aligned with the frame 925A of the original video 900, and the mismatching of the customized videos 915 and 920 can be avoided.

As also depicted in FIG. 9, the frame 935B of the intermediate video 910 is faster than the frame 935A of the original video 900. In order to align the timing of the frame 935B with the timing of the frame 935A, the intermediate video 910 can be slowed down so that the frame 935B can be aligned with the frame 935A. The aligned frame 935B of the intermediate video 910 corresponds to the frame 935C of the customized video 920.

Further, since the intermediate videos 905 and 910 can interact with each other, only slowing down the intermediate video 910 can cause a mismatching of the frame 940B of the intermediate video 905 with the frame 935B of the intermediate video 910. In order to avoid the mismatching, the intermediate video 905 is slowed down simultaneously with the intermediate video 910.

In this way, as depicted by the dashed line in FIG. 9, not only the frame 935C of the customized video 920, but also the frame 940C of the customized video 915, which corresponds to the frame 940B of the intermediate video 905, is aligned with the frame 935A of the original video 900, and the mismatching of the customized videos 915 and 920 can be avoided.

After the above synchronization, the customized videos 915 and 920 are combined in the same video to generate the customized video similar to the original video 900. In the customized video including the customized videos 915 and 920, mismatching of the customized videos 915 and 920 can be avoided due to the simultaneous synchronization of the two intermediate videos. It can be understood that although FIG. 9 relates to the synchronization of two intermediate videos, the synchronization method according to the present disclosure can also be applied in the cases where more than two intermediate videos need to be synchronized.

It can also be understood that the synchronization methods described with reference to FIGS. 7-9 are example synchronization methods, and other synchronization methods can also be applied in the present disclosure.

The present disclosure may be a system, a method, and/or a computer program product at any possible technical detail level of integration. The computer program product may include a computer-readable storage medium, or media, having computer-readable program instructions thereon for causing a processor to carry out aspects of the present disclosure.

According to embodiments of the present disclosure, there is provided a system for real-time video sharing. The system may comprise one or more processor circuits and a memory that is electrically coupled to at least one of the one or more processor circuits. The system may further comprise a set of computer program instructions stored in the memory and executed by at least one of the one or more processor circuits in order to perform an action of generation at least one real-time customized video similar to an original video based on at least one user device setting. The system may further comprise a set of computer program instructions stored in the memory and executed by at least one of the one or more processor circuits in order to perform an action of receiving setting information received from a user device from which a view request for the original video was received. The system may further comprise a set of computer program instructions stored in the memory and executed by at least one of the one or more processor circuits in order to perform an action of providing one of the at least one real-time customized video to the user based on the received setting information received from the user device.

According to embodiments of the present disclosure, there is provided a computer program product. The computer program product may comprise a computer-readable storage medium having program instructions embodied therewith. The program instructions may be executable by a device to perform a method for real-time video sharing. The method may comprise generation at least one real-time customized video similar to an original video based on at least one user device setting. The method may further comprise receiving setting information received from a user device from which a view request for the original video was received. The method may further comprise providing one of the at least one real-time customized video to the user based on the received setting information received from the user device.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media, e.g., light pulses passing through a fiber-optic cable, or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer, for example, through the Internet using an Internet Service Provider. In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational operations to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks depicted in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A computer-implemented method for providing, to a user device, a real-time customized video, the method comprising:
generating, with at least one processor circuit, in response to receiving the user's permission to allow collection of the at least one user device setting, at least one real-time customized video created from and similar to an original video, wherein the generating is based upon at least one user device setting;
that:
is received from the user device from which a view request for the original video was received;
is specified solely by the user;
is most similar to the setting information received from the user device;
includes a group of settings that are most commonly used; and
receiving, with the at least one processor circuit, setting information from a user device from which a view request for the original video was received; and
providing, to the user device, with the at least one processor circuit, based on the setting information received from the user device, a video of the at least one real-time customized video.

2-4. (canceled)

5. The computer-implemented method of claim 1, wherein the generating includes:
creating at least one virtual machine that is configured according to the at least one user device setting;
replaying, on the at least one virtual machine, in order to record at least one respective intermediate video, video operations from the original video; and
synchronizing the at least one intermediate video with the original video to generate the at least one real-time customized video.

6. The computer-implemented method of claim 5, wherein the synchronizing includes:
identifying first timings of at least one first frame in the original video;
identifying, in the at least one intermediate video corresponding to the at least one first frame in the original video, second timings of at least one second frame; and
aligning each timing of the second timings with corresponding first timings.

7. The computer-implemented method of claim 6, wherein an additional intermediate video is synchronized with the original video and combined to generate the real-time customized video, and wherein the aligning includes, for each of the second timings, simultaneously performing, to align each timing of the second timings with corresponding first timings, an operation selected from the group consisting of: fast-forwarding the at least two intermediate videos, and slowing down the at least two intermediate videos.

8. (canceled)

9. A system for providing, to a user device, a real-time customized video, the system comprising:
at least one processor circuit;
a memory electrically coupled to the at least one processor circuit;
a set of computer program instructions stored in the memory and executed by the at least one processor circuit in order to perform a method comprising:
generating, in response to receiving the user's permission to allow collection of the at least one user device setting, at least one real-time customized video that is created from and is similar to an original video based upon at least one user device setting that:
is received from the user device from which a view request for the original video was received;
is specified solely by the user;
is most similar to the setting information received from the user device; and
includes a group of settings that are most commonly used; and
receiving setting information from a user device from which a view request for the original video was received; and
providing, to the user device, based on the setting information received from the user device, a video of the at least one real-time customized video.

10-11. (canceled)

12. The system of claim 9, wherein the generating includes:
creating at least one virtual machine that is configured according to the at least one user device setting;
replaying, on the at least one virtual machine, in order to record at least one respective intermediate video, video operations from the original video; and
synchronizing the at least one intermediate video with the original video to generate the at least one real-time customized video.

13. The system of claim 12, wherein the synchronizing includes:
identifying first timings of at least one first frame in the original video;
identifying, in the at least one intermediate video corresponding to the at least one first frame in the original video, second timings of at least one second frame; and
aligning each timing of the second timings with corresponding first timings.

14. The system of claim 13, wherein an additional intermediate video is synchronized with the original video and combined to generate the real-time customized video, and wherein the aligning includes, for each of the second timings, simultaneously performing, to align each timing of the second timings with corresponding first timings, an operation selected from the group consisting of: fast-forwarding the at least two intermediate videos, and slowing down the at least two intermediate videos.

15. A computer program product comprising a computer-readable storage medium having program instructions embodied therewith, wherein the computer-readable storage medium is not a transitory signal per se, wherein the program instructions are executable by a computing device to perform a method for providing, to a user device, a real-time customized video, the method comprising:
generating, in response to receiving the user's permission to allow collection of the at least one user device setting, at least one real-time customized video that is created from and is similar to an original video based upon at least one user device setting that:
is received from the user device from which a view request for the original video was received;
is specified solely by the user;
is most similar to the setting information received from the user device; and
includes a group of settings that are most commonly used; and
receiving setting information from a user device from which a view request for the original video was received; and
providing, to the user device, based on the setting information received from the user device, a video of the at least one real-time customized video.

16-17. (canceled)

18. The computer program product of claim 15, wherein the generating includes:
creating at least one virtual machine that is configured according to the at least one user device setting;
replaying, on the at least one virtual machine, in order to record at least one respective intermediate video, video operations from the original video; and
synchronizing the at least one intermediate video with the original video to generate the at least one real-time customized video.

19. The computer program product of claim 18, wherein the synchronizing includes:
identifying first timings of at least one first frame in the original video;
identifying, in the at least one intermediate video corresponding to the at least one first frame in the original video, second timings of at least one second frame; and
aligning each timing of the second timings with corresponding first timings.

20. The computer program product of claim 19, wherein an additional intermediate video is synchronized with the original video and combined to generate the real-time customized video, and wherein the aligning includes, for each of the second timings, simultaneously performing, to align each timing of the second timings with corresponding first timings, an operation selected from the group consisting of: fast-forwarding the at least two intermediate videos, and slowing down the at least two intermediate videos.

21. The computer-implemented method of claim 1, wherein the at least one user device setting includes a setting selected from the group consisting of: a language preference setting, and a screen layout of the user device.

22. The system of claim 9, wherein the at least one user device setting includes a setting selected from the group consisting of: a language preference setting, and a screen layout of the user device.

23. The computer program product of claim 15, wherein the at least one user device setting includes a setting selected from the group consisting of: a language preference setting, and a screen layout of the user device.
